(19) United States
(12) Patent Application Publication
(10) Pub. No.: US 2015/0234634 A1
(43) Pub. Date: Aug. 20, 2015

(54) MULTIPLE NETWORKING IN AUDIO PROCESSING SYSTEM

(71) Applicant: Yamaha Corporation, Hamamatsu-Shi (JP)

(72) Inventors: Yuki FURUMOTO, Hamamatsu-Shi (JP); Takao YOKOI, Hamamatsu-Shi (JP)

(21) Appl. No.: 14/626,699

(22) Filed: Feb. 19, 2015

(30) Foreign Application Priority Data
Feb. 20, 2014 (JP) 2014-030826

(51) Int. Cl. G06F 3/16

(52) U.S. Cl. CPC G06F 3/165

(57) ABSTRACT

An audio processing system includes a console (control device), an engine (processing device) and an I/O unit (input/output device). The console and the engine are communicatively interconnected via a first-type network. The engine and the I/O unit are communicatively interconnected via a second-type network. When the console is connected to the first-type network, the console can remote-control the engine and the I/O unit. However, when the console is connected to the second-type network, the remote-control, by the console, on the engine and the I/O unit is invalidated. When the I/O unit is connected to the second-type network, audio signals can be input/output to/from the I/O unit. When the I/O unit is connected to the first-type network, input/output of audio signal in the I/O unit is invalidated. The present invention permits efficient use of the networks with the console using the first-type network and the I/O unit using the second-type network.

### BACKGROUND

The present invention relates to multiple networking in an audio processing system which includes an input/output device for inputting/outputting audio signals, a processing device for processing the audio signals, and a control device for remote-controlling the input/output device and the processing device.

There have heretofore been known network-type audio processing systems which comprise: an input/output device (hereinafter referred to also as an “I/O unit”) for inputting/outputting a plurality of audio signals; a processing device (hereinafter referred to also as an “engine”) for performing various signal processing, such as mixing processing, on the plurality of audio signals; and a control device (hereinafter referred to also as a “console”) including a user interface (hereinafter referred to also as a “UI”) for remote-controlling behavior or operation of the input device and the processing device, and in which these input/output, processing and control devices are interconnected via a network. In this specification, a combination of a series of signal processing functions from input to output of audio signals, the UI for controlling such signal processing functions, etc. will hereinafter be referred to as an “audio processing system”. Further, in this specification, one type of such an audio processing system where an engine performs mixing processing on audio signals in a plurality of processing channels will hereinafter be referred to as a “mixer system”. Furthermore, in this specification, such a mixer system will be described below as a specific example of the audio processing system. Moreover, in this specification, control performed for, in response to a human operator's operation on a UI of a given device, setting values of parameters stored in another device for controlling behavior or operation of the other device will be referred to as “remote control”. Furthermore, control performed for, in response to a human operator's operation on a UI of a given device, setting values of parameters stored in the given device for controlling operation of the given device will be referred to as “local control”.

In the case where the signal processing from input to output of audio signals is performed in a shared manner by the networked console, engine and I/O unit (i.e., networked devices) as noted above, these networked devices together constitute one mixer system. Japanese Patent Application Laid-open Publication No. 2010-226537 (hereinafter referred to as “Patent Literature 1”) discloses an example of such a network-type mixer system. The network interconnecting the devices can not only time-divisionally transmit audio signals via a predetermined number of (e.g., 512) audio transmitting channels, but also transmit various control data including control data for remote-controlling the engine and the I/O unit from or via the console. Note that the audio transmitting channels (also referred to simply as “transmitting channels”) correspond to bands for transmitting audio signals over the network in a multiplexed fashion and are different in concept from processing channels each having an audio signal processing function.

Further, Japanese Patent No. 4930757 (hereinafter referred to as “Patent Literature 2”) discloses a network-type mixer system in which a plurality of networks are interconnected so that audio signal transmitting bands (i.e., the number of audio transmitting channels) in the entire mixer system can be expanded by the number of the interconnected networks.

In each of the conventionally-known mixer systems disclosed in Patent Literatures 1 and 2, whether the mixer system comprises a single common network or a plurality of common networks, the console, the engine and the I/O unit are connected to the common network(s) so that a plurality of audio signals and various control data other than the audio signals are transmitted via the common network(s). Therefore, in a case where a multiplicity of I/O units are connected to the network(s) and thus a multiplicity of input ports and a multiplicity of output ports (hereinafter referred to simply as “ports” when it is not necessary to distinguish between the input ports and the output ports) are used in the mixer system, bands used for transmitting control data of the console may sometimes be undesirably pressed by a multiplicity of audio signals flowing over the network(s) and control data (e.g., data of port-specific sound volume level meters) transmitted by the multiplicity of I/O units. Of the control data transmitted by the I/O units, the data of the port-specific sound volume level meters particularly press the bands of the network(s). As a consequence, a response to a UI operation on the console would considerably deteriorate. If many network bands are allocated for transmitting the control data in order to prevent such deterioration of the response, the bands usable for transmitting the audio signals would decrease, so that audio signal transmission performance of the mixer system cannot be exerted sufficiently.

### SUMMARY OF THE INVENTION

In view of the foregoing prior art problems, it is an object of the present invention to provide an improved audio processing system which can not only prevent deterioration of a response to a human operator's operation in remote controlling another device via a console but also sufficiently exert audio signal transmission performance of the audio processing system by avoiding reduction in bands of a network to be used for transmission of audio signals.

In order to accomplish the above-mentioned object, an audio processing system according to a first aspect of the present invention comprises: at least one input/output device configured to input/output an audio signal; at least one processing device configured to process the audio signal; at least one control device configured to remote-control the processing device and the input/output device; a first-type network for communicatively interconnecting the control device and the processing device; and a second-type network for communicatively interconnecting the processing device and the input/output device, wherein the control device is further configured to invalidate remote control thereby on the processing device and the input/output device when the control device is connected to the second-type network.

According to the first aspect of the present invention, the processing device and the input/output device can be remote-controlled via the control device as long as the control device is connected to the first-type network. However, when the control device has been erroneously connected to the second-type network, the processing device and the input/output device can no longer be remote-controlled via the control device. Namely, because the first-type network is used exclusively for the purpose of transmission of remote-controlling data from the control device, communication bands to be used for the remote-controlling data transmission from the control device can be stably secured independently of communication bands of the second-type network via which audio signals are input/output by the input/output device. Also, the present invention can reliably prevent the control device from being used erroneously connected to the second-type network. Such arrangements can reliably eliminate the inconvenience that the bands of the second-type network usable for audio signal transmission are undesirably reduced by the control device, erroneously connected to the second-type network, transmitting remote-controlling data. Thus, the present invention can not only prevent deterioration of a response to a human operator's operation in remote controlling the processing device and the input/output device via the control device but also sufficiently exert audio signal transmission performance by avoiding reduction in the bands of the second-type network to be used for transmission of audio signals.

Further, in order to accomplish the above-mentioned object, an audio processing system according to a second aspect of the invention comprises: at least one input/output device configured to input/output an audio signal; at least one processing device configured to process the audio signal; at least one control device configured to remote-control the processing device and the input/output device; a first-type network for communicatively interconnecting the control device and the processing device; and a second-type network for communicatively interconnecting the processing device and the input/output device, wherein at least one of the control device and the input/output device is further configured to invalidate input/output of an audio signal in the input/output device when the input/output device is connected to the first-type network.

According to the second aspect of the present invention, audio signal input/output in (i.e., to/from) the input/output device is permitted as long as the input/output device is connected to the second-type network. However, when the input/output device has been connected to the first-type network, the present invention invalidates audio signal input/output in the input/output device. Thus, the present invention can reliably prevent the input/output device from being erroneously connected to the first-type network. In this way, the present invention can prevent communication bands of the first-type network from being pressed by audio signals input/output to/from the input device. As a result, the present invention can not only prevent deterioration of a response to a human operator's operation in remote controlling the processing device and the input/output device via the control device but also sufficiently exert the audio signal transmission performance by avoiding reduction in the bands of the second-type network to be used for transmission of audio signals.

Further, in order to accomplish the above-mentioned object, the present invention provides a control device in an audio processing system according to a third aspect of the present invention which comprises: at least one input/output device configured to input/output an audio signal; at least one processing device configured to process the audio signal; the control device configured to remote-control the processing device and the input/output device; a first-type network for communicatively interconnecting the control device and the processing device; and a second-type network for communicatively interconnecting the processing device, connected to the first-type network, and the input/output device, and in which the control device is further configured to invalidate remote control thereby on the processing device and the input/output device when the control device is connected to the second-type network.

Furthermore, in order to accomplish the above-mentioned object, the present invention provides a control device in an audio processing system according to a fourth aspect of the present invention which comprises: at least one input/output device configured to input/output an audio signal; at least one processing device configured to process the audio signal; the control device configured to remote-control the processing device and the input/output device; a first-type network for communicatively interconnecting the control device and the processing device; and a second-type network for communicatively interconnecting the processing device, connected to the first-type network, and the input/output device, and in which the control device is further configured to invalidate input/output of an audio signal in the input/output device when the input/output device is connected to the first-type network.

Furthermore, in order to accomplish the above-mentioned object, the present invention provides a processing device in an audio processing system according to a fifth aspect of the present invention which comprises: at least one input/output device configured to input/output an audio signal; the processing device configured to process the audio signal; at least one control device configured to remote-control the processing device and the input/output device; a first-type network for communicatively interconnecting the control device and the processing device; and a second-type network for communicatively interconnecting the processing device, connected to the first-type network, and the input/output device, and in which the processing device is further configured to accept remote control by the control device when the control device is connected to the processing device via the first-type network, and refuse the remote control by the control device when the control device is connected to the processing device via the second-type network.

The present invention constructed in the aforementioned manner can achieve the superior benefit that it can prevent deterioration of a response to a human operator's operation in remote controlling the processing device and the input/output device via the control device but also sufficiently exert the audio signal transmission performance by avoiding reduction in the bands of the second-type network to be used for transmission of audio signals.

The present invention may be constructed and implemented not only as the apparatus invention discussed above but also as a method invention. Also, the present invention may be arranged and implemented as a software program for execution by a processor, such as a computer or DSP, as well as a non-transitory computer-readable storage medium storing such a software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

Certain preferred embodiments of the present invention will hereinafter be described in detail, by way of example only, with reference to the accompanying drawings, in which:

FIG. 1 is a block diagram showing an example overall setup of a mixer system to which is applied an embodiment of an audio processing system of the present invention;

FIG. 2A is a block diagram showing an electric hardware setup of a console (control device) or a PC of FIG. 1;

FIG. 2B is a block diagram showing an electric hardware setup of an engine (processing device) or a mixer of FIG. 1;

FIG. 2C is a block diagram showing an electric hardware setup of an I/O unit (input/output device) of FIG. 1;

FIG. 3 is a block diagram explanatory of arrangements of a signal processing function in the mixer system of FIG. 1;

FIG. 4 is a flow chart of main processing performed by each device in the mixer system of FIG. 1;

FIG. 5 is a flow chart of a process performed when the console has newly detected a device on a first-type network or on a second-type network;

FIG. 6 is a flow chart of a process performed by the engine in response to a control request;

FIG. 7 is a flow chart of a process performed when the engine has newly detected a device on the second-type network; and

FIG. 8 is a flow chart of a value change operation process that is an example of communication between the console and another device, where (a) is a flow chart of a process performed by the console, (b) is a flow chart of a process performed by the engine, and (c) is a flow chart of a process performed by the I/O unit.

### DETAILED DESCRIPTION

The following describe, with reference to the accompanying drawings, an embodiment of an audio processing system of the present invention and more specifically a mixer system to which is applied an embodiment of the audio processing system of the present invention.

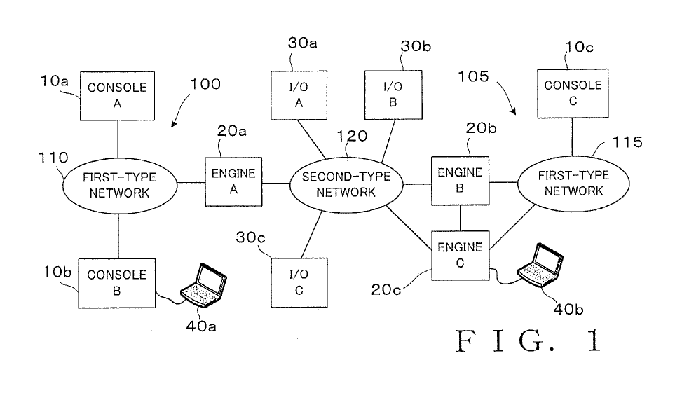

FIG. 1 is a block diagram showing an example overall setup of the mixer system to which is applied the embodiment of the audio processing system of the present invention. In FIG. 1, consoles 10a, 10b and 10c (“Console A”, “Console B” and “Console C”) each include a user interface (UI) operable by a human operator for controlling signal processing of the one mixer system that is a common object of control. Engines 20a, 20b and 20c (“Engine A”, “Engine B” and “Engine C”) each include a plurality of processing channels for performing signal processing on audio signals. Further, I/O units 30a, 30b and 30c (“I/O A”, “I/O B” and “I/O C”) each include a plurality of input ports for inputting audio signals from the outside and/or a plurality of output ports for outputting audio signals to the outside (hereinafter referred to simply as “ports” when it is not necessary to distinguish between the input ports and the output ports). Note that each of the consoles 10a, 10b and 10c and the engines 20a, 20b and 20c too includes a plurality of ports. Further, in FIG. 1, alphabetical suffixes “a”, “b”, . . . are added to the reference numerals 10, 20 and 30 in order to distinguish among individual ones of the three consoles 10a, 10b and 10c, among individual ones of the three engines 20a, 20b and 20c and among individual ones of the I/O units 30a, 30b and 30c. In the following description, however, reference numerals 10, 20 and 30 with no such alphabetical suffixes are used for the devices when there is no need to distinguish among the individual devices.

In the illustrated example of FIG. 1, there are provided two independent mixer systems, i.e., a first mixer system 100 which controls a series of signal processing functions from input to output of audio signals in response to UI operations on the consoles 10a and 10b, and a second mixer system 105 which controls a series of signal processing functions from input to output of audio signals in response to a UI operation on the console 10c. The signal processing in the first mixer system 100 and the signal processing in the second mixer system 105 are controlled independently of each other.

In the first mixer system 100, as seen in FIG. 3, the engine 20a performs the signal processing on audio signals, input/output to/from the individual ports of the engines 20a and 20b and I/O units 30a and 30b, in response to UI operations on the consoles 10a and 10b. The signal processing functions of the first mixer system 100 (i.e., digital signal processing from input to output assigned to the consoles 10a and 10b, the engines 20a and 20b and the I/O units 30a and 30b) are controlled in accordance with various parameters set in response to UI operations on the console 10a or 10b. Namely, the signal processing functions of the first mixer system 100 can be controlled in response to UI operations on any one of the consoles 10a or 10b. Note that, in the first mixer system 100, the engine 20b uses only the audio input/output function using a plurality of ports provided therein and does not use the audio signal processing functions using the plurality of processing channels. Namely, the first mixer system 100 handles the engine 20b as an equivalent of the I/O unit 30. Further, the engine 20b and the I/O unit 30a use a portion of their respective ports for the signal processing of the first mixer system 100 and use another portion of the respective ports for the signal processing of the second mixer system 105. In the following description, using a portion of the ports in a given device in a given mixer system and another portion of the ports in another mixer system, i.e. sharing a plurality of ports provided in a given device between a plurality of mixer systems, will be referred to as “I/O share”.

Of the various devices constituting the first mixer system 100, as further shown in FIG. 1, the consoles 10a and 10b and the engine 20a are interconnected via a first-type network (“First-type Network A”) 110, and the engine 20a and 29b and the I/O units 30a and 30b are interconnected via a second-type network (“Second-type Network B”) 120. The first-type network 110 and the second-type network 120 can each time-divisionally transmit a plurality of audio signals and a plurality of control data. As such a first-type network 110 and second-type network 120, there may be employed any suitable networks capable of transmitting in real time a plurality of audio signals and a plurality of control data, such as the network disclosed in the aforementioned Patent Literature 1 (Japanese Patent Application Laid-open Publication No. 2010-226537), “EtherSound” (registered trademark), “Cobranet” (registered trademark), “Dante” (registered trademark) and “AVB” (registered trademark).

The first-type network 110 interconnects the consoles 10a and 10b and the engine 20a, and the first-type network 110 is used exclusively for transmitting control data (remote-controlling data) for remote controlling the engine 20 via the console 10a or 10b. No I/O unit 30 is connected to the first-type network 110. When any I/O unit 30 is erroneously connected to the first-type network 110, then the ports of the I/O unit 30 are invalidated, as noted later. Although the first-type network 110 transmits audio signals input/output to/from the ports provided in the consoles 10a and 10b and the engine 20a, the number of audio signals that are required to be transmitted via the first-type network 110 is very small. Thus, audio signal transmitting bands (audio transmitting channels) (e.g., 64 audio signal transmitting bands or audio transmitting channels) of the first-type network 110 are smaller in number than audio signal transmitting bands (audio transmitting channels) of the second-type network 120.

The second-type network 120 interconnects the engine 20a that performs signal processing on a plurality of audio signals and various devices (i.e., the I/O units 30a and 30b and the engine 20b) that input/output a plurality of audio signals, and the second-type network 120 is used for communicating a multiplicity of audio signals input/output to/from many ports provided in such devices. Thus, the audio transmitting channels (e.g., 512 audio transmitting channels) of the second-type network 120 are greater in number than the audio transmitting channels of the first-type network 110. No console 10 is connected to the second-type network 120. When any console 10 is erroneously connected to the second-type network 120, then remote control on the engine 20 and the I/O units 30 via the erroneously-connected console 10 is invalidated, as noted later.

Examples of control data communicated via the first-type network 110 and the second-type network 120 include control data (e.g., parameter value change instruction) for remote-controlling operation of another device in response to a UI operation on the console 10, a parameter value change result returned from the other device in response to the remote control performed via the console 10, sound volume level meter data for each of audio signals of individual ports provided in each of the devices belonging to the first mixer system 100, etc. The term “remote control” used in this specification refers to control performed for, in response to a UI operation on a given device (e.g., console 10a or 10b of the first mixer system 100), setting values of parameters stored in any of other devices (e.g., the engines 20a and 20b and I/O units 30a and 30b of the first mixer system 100) for controlling behavior or operation of the other device.

In the second mixer system 105, on the other hand, the engine 20b and/or the engine 20c performs, in response to a UI operation on the console 10c, signal processing on audio signals input/output to/from, for example, individual ports of the engine 20b, the engine 20c (“Engine C” in FIG. 1) and the I/O units 30a and 30b. Of the various devices constituting the second mixer system 105, the console 10c and the engines 20b and 20c are interconnected via the first-type network 115 (“First-type Network A”), and the engines 20b and 20c and the I/O units 30a and 30c are interconnected via the second-type network 120. The first-type network 115 is a network which interconnects the console 10 and the engine 20 similarly to the aforementioned first-type network 110 of the first mixer system 100. But, the first-type network 115 is different from the first-type network 110 dedicated to the first mixer system 100 in that it is dedicated to the second mixer system 105. In the second mixer system 105 constructed in the aforementioned manner, remote controlling data can be transmitted from the console 10c to the engine 20b and/or the engine 20c via the first-type network 115, but a multiplicity of audio signals input/output to/from the individual ports of the engines 20b and 20c and the I/O units 30a and 30c can be transmitted via the second-type network 120.

Where two engines 20b and 20c are connected to the first-type network 115 as in the second-type mixer system 105, each of the two engines 20b and 20c may perform signal processing independently of the other of the two engines so that second mixer system 105 can expand a signal processing capability as a whole. Alternatively, only one of the two engines 20b and 20c may perform the signal processing and the other of the two engines 20b and 20c may be maintained in a standby state as a backup engine.

The I/O unit 30 shown in FIG. 1 corresponds to an input/output device that inputs/outputs one or more audio signals, the engine 20 corresponds to a processing device that processes the audio signals, and the console 10 corresponds to a control device that remote-controls the processing device and the input/output device. Further, the first-type network 110 or 115 corresponds to a first-type network that interconnects the control device and the processing device, the second-type network 120 corresponds to a second-type network that interconnects the processing device and the input/output device, and the first mixer system 100 or the second mixer system 105 corresponds to an audio processing system. The following description will be given, focusing exclusively on the first mixer system 100.

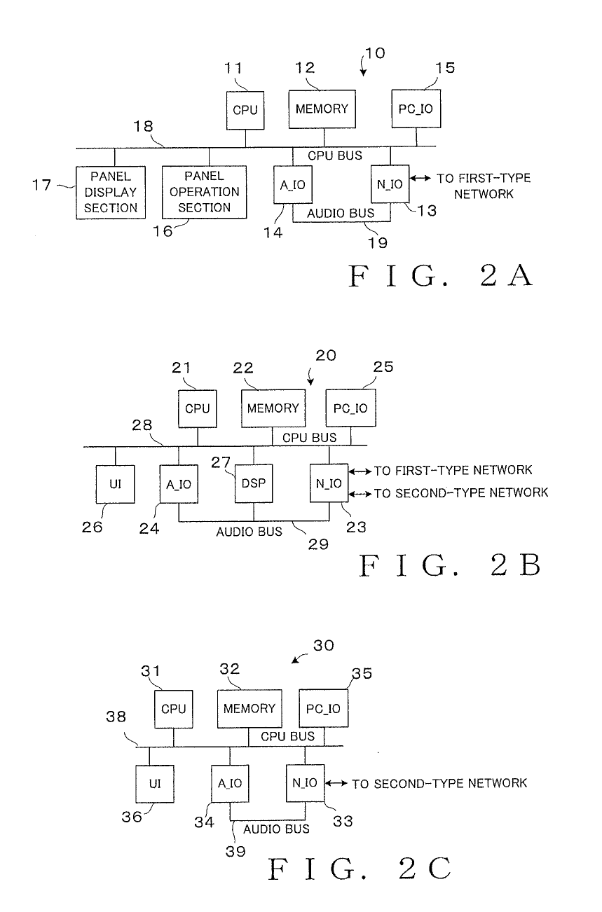

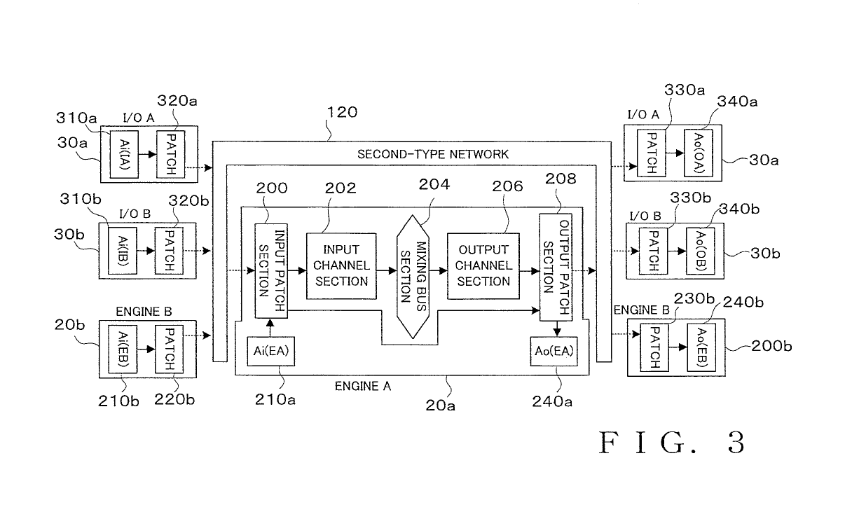

FIG. 2A is a block diagram showing an electric hardware setup of the console 10. The console 10 includes a CPU 11, a memory 12, a network interface (“N_IO”) 13, an audio interface (“A_IO”) 14, a PC interface (PC_IO) 15, a panel operation section (“P Operation Section”) 16 and a panel display section (“P display section”) 17, which are interconnected via a CPU bus 18. Further, the N_IO 13 and the A_IO 14 are interconnected via an audio bus 19 that transmits digital audio signals between desired ones of a plurality of blocks connected thereto.

The CPU 11 controls general behavior or operation of the console 10 by executing a control program stored in the memory 12. The memory 12 may comprise a desired combination of various storage means, such as a ROM, a RAM, a flash memory and an HDD. In the memory 12 are stored not only various control programs including control programs necessary for the CPU 11 to function as a control device of the first mixer system 100, but also values of various parameters for controlling operation of the CPU 11, values of various parameters for remote-controlling operation of the engine 20 and values of various parameters for remote-controlling operation of the I/O unit 30, etc.

The N_IO 13 includes one connector for connection to the first-type network 110 so that the console 10 is connected to the first-type network 110 via the N_IO 13. The N_IO 13 can receive one or more audio signals and various control data from another device connected to the first-type network 110 and transmit one or more audio signals and various control data to another device connected to the first-type network 110.

The A_IO 14 is an audio interface including a plurality of input ports for receiving analog or digital audio signals, converting, as necessary, the received audio signals into digital audio signals for signal processing in the mixer system and outputting the converted audio signals to the audio bus 19, and/or, a plurality of output ports for converting digital audio signals, supplied from the audio bus 19, into analog or digital audio signals for use in external equipment and outputting the converted audio signals to the external equipment. Examples of the external equipment which the A_IO 14 is connected to include not-shown audio output equipment or audio input equipment.

The panel operation section 16 and the panel display section 17 are user interfaces provided on an operation panel of the console 10. The panel operation section 16 includes fader operators provided in corresponding relation to a plurality of channel strips (i.e., channel-specific operation sections), a multiplicity of ON/OFF switches, a multiplicity of rotary operators, etc. The panel display section 17, which is in the form of a liquid crystal display of a relatively large size capable of displaying, for example, 100 characters or over, displays values of various parameters and various information. The panel display section 17 can also display various other information, such as a warning to a human operator and information of a device found on a network. The PC_IO 15 is an interface that connects a personal computer (PC) to the console 10.

Further, FIG. 2B is a block diagram showing an electric hardware setup of the engine 20. The engine 20 includes a CPU 21, a memory 22, an N_IO 23, an A_IO 24, a PC_IO 25, a user interface (UI) 26 and a signal processing section (digital signal processor or DSP) 27, which are interconnected via a CPU bus 28. Further, the N_IO 23, the A_IO 24 and the DSP 27 are interconnected via an audio bus 29 that transmits digital audio signals between desired ones of a plurality of blocks connected thereto.

The CPU 21 controls general operation of the engine 20 by executing a control program stored in the memory 22. The memory 22 may comprise a desired combination of various storage means, such as a ROM, a RAM, a flash memory and an HDD. In the memory 22 are stored not only the control program for controlling the operation of the engine 20, but also values of various parameters for controlling operation of the CPU 21, values of various parameters for remote-controlling operation of the I/O unit 30, and a program for signal processing to be executed by the DSP 27.

The N_IO 23 includes a first connector for connection to the first-type network 110, and a second connector for connection to the second-type network 120. The engine 20 is connected to the two, i.e. first-type and second-type, networks 110 and 120. The N_IO 23 can not only receive one or more audio signals and various control data from another device connected to the first-type network 110 and transmit one or more audio signals and various control data to another device connected to the first-type network 110, but also receive one or more audio signals and various control data from another device connected to the second-type network 120 and transmit one or more audio signals and various control data to another device connected to the second-type network 120. The A_IO 24, which is an audio interface similar to the aforementioned A_IO 14, includes a plurality of input ports and/or a plurality of output ports. Further, the PC_IO 25 is an interface similar to the aforementioned PC_IO 15 and serves to connect a PC to the engine 20.

The signal processing section (DSP) 27 receives one or more audio signals from the N_IO 23 or the A_IO 24 via the audio bus 29, then performs digital signal processing on the received one or more audio signals on a processing-channel-by-processing-channel basis by executing a signal processing program, and then outputs the thus-processed audio signals (results of the signal processing) to the N_IO 23 or the A_IO 24 via the audio bus 29. The digital signal processing performed by the DSP 27 on the processing-channel-by-processing-channel basis as above includes routing of the audio signals, adjustment of tone characteristics (e.g., tone volume levels and qualities) of the audio signals, mixing processing of the audio signals, effect processing on the audio signals, etc. Values of parameters for the digital signal processing to be performed by the DSP 27 are stored in the memory 22. Such values of parameters for the digital signal processing to be performed by the DSP 27 are set on the basis of control data received from the console 10 via the first-type network 110.

Further, the UI 26 is a simplified user interface as compared to a user interface (including, for example, 500 or more ON/OFF switches, 10 or more rotary operators and a display capable of displaying 100 or more characters) provided in the conventional mixing consoles. For example, the UI 26 includes about 10 ON/OFF switches, several parameter value setting operators and a display capable of displaying about 10 characters.

Further, FIG. 2C is a block diagram showing an electric hardware setup of the I/O unit 30. The I/O unit 30 includes a CPU 31, a memory 32, an N_IO 33, an A_IO 34, a PC_IO 35 and a UI 36, which are interconnected via a CPU bus 38. Further, the N_IO 33 and, the A_IO 34 are interconnected via an audio bus 39 that transmits digital audio signals between desired ones of a plurality of blocks connected thereto.

The CPU 31 controls general operation of the I/O unit 30 by executing a control program stored in the memory 32. The memory 32 may comprise a desired combination of various storage means, such as a ROM, a RAM, a flash memory and an HDD. In the memory 32 are stored not only the control program for controlling the operation of the I/O unit 30 and values of various parameters for controlling operation of the I/O unit 30.

The N_IO 33 includes one connector for connection to the second-type network 120 so that the I/O unit 30 is connected to the second-type network 120 via the N_IO 33. The N_IO 33 can receive one or more audio signals and various control data from another device connected to the second-type network 120 and transmit one or more audio signals and various control data to another device connected to the second-type network 120.

The A_IO 34, which is an audio interface similar to the aforementioned A_IO 14, includes a plurality of input ports and/or a plurality of output ports. The I/O unit 30 inputs audio signals from not-shown external equipment (e.g., a microphone, an electronic equipment, a recorder or the like) via the individual input ports and outputs audio signals to not-shown external equipment (e.g., a power amplifier, a recorder, a powered speaker or the like) via the output ports. Further, the PC_IO 35 is a PC-connecting user interface similar to the aforementioned CIO's 15 or 25, and the UI 36 is a simplified user interface including, for example, several ON/OFF switches and parameter-value-setting operators, etc.

FIG. 3 is a block diagram explanatory of an example operational flow of digital signal processing on audio signals in the first mixer system 100 shown in FIG. 1. The digital signal processing on audio signals illustrated in FIG. 3 is based on the assumption that the system is constructed in such a manner that signal processing, including mixing processing etc., are performed, by the engine 20a acting as a central component, on a plurality of audio signals input via the respective input ports of the I/O units 30a and 30b and the engines 20a and 20b and then the processed audio signals (results of the processing) are output to the respective output ports of the I/O units 30a and 30b and the engines 20a and 20b. Note that illustration of elements pertaining to the input/output ports of the consoles 10a and 10b connected to the first-type network 110 (i.e., transmission of audio signals using the first-type network 110) is omitted from FIG. 3, and that, for the engine 20b, only audio signal input/output functions are illustrated in FIG. 3. Further, in the example connections among the devices shown in FIG. 1, audio processing (not-shown) in the second mixer system 105 is performed, by the engines 20b and 20c acting as central components, in parallel with and similarly to the digital signal processing shown in FIG. 3.

Each of the I/O units 30a and 30b and the engines 20a and 20b inputs audio signals from the outside via its one or more input ports 310a, 310b, 210a or 210b (“Ai(IA)”, “Ai(IB)”, “Ai(EA)” or “Ai(BE)”). The input ports 310a, 310b, 210a and 210 correspond to the A_IO 24 and A_IO 34 of FIGS. 2A and 2B.

A patch section 320a, 320b, 220b or 200 (330a, 330b, 230b or 208) of each of the devices supplies, on the basis of a connection (hereinafter referred to as a “patch”) set for each of the input ports (supply sources) of the device, supplies an audio signal of that input port to a supply destination corresponding to the patch. In the following description, the term “patch” is used to refer to allocating, in response to a human operator's patch setting operation (connection instruction), any one of the supply sources of audio signals to any one of the supply destinations of audio signals so that an audio signal can flow from the allocated supply source to the supply destination. The supply destination receives the audio signal from the supply source and performs processing on the received audio signal. Although one supply source can be connected or patched to two or more supply destinations, only one supply source can be patched to one supply destination. The human operator can make patch settings by performing UI operations on the console 10a or 10b.

If a supply destination of a patch set for a given input port of a given device is a processing channel or an output port in the same device, the patch section 320a, 320b, 220b, 200 (or 330a, 330b, 230b, 208) of the device supplies an audio signal of the given input port directly to that processing or output port. If, on the other hand, a supply destination of a patch set for a given input port of a given device is an output port in another device, then an audio signal of the given input port is supplied to the other device, set as a supply destination, via the second-type network 120 and by use of a processing channel of the second-type network 120 secured in advance by that device. In such a case, the N_IO 13, 23 or 33 of the device gives transmission information, indicative of the transmitting channel carrying the audio signal of the given input port and the supply destination, to the other device on the second-type network 120.

On the basis of each of the patches having been set on the console 10a or 10b and the transmission information from another device, the engine 20a identifies, from among the transmitting channels possessed by the second-type network, a transmitting channel via which an audio signal should be received, and then the engine 20a sets the N_IO 23 to receive the audio signal of the identified transmitting channel. The N_IO 23 receives the audio signal of each of the thus-set transmitting channels from among the transmitting channels possessed by the second-type network 120. On the basis of each of the set patches, the input patch section 200 supplies an audio signal from a specific supply source to an input channel (supply source) 202. Namely, if the supply source in a given one of the set patches is an input port 210a in the engine 20a, the input patch section 200 supplies an audio signal of the input port 210a to the input channel 202 set as the supply destination in the patch. If the supply source in a given one of the set patches is a supply source in another device, the input patch section 200 supplies an audio signal of the supply source, received via the N_IO 23, to an input channel 202 set as the supply destination in the patch. Note that, in the specification, a processing channel that performs digital signal processing on an audio signal input to the mixer system will be referred as an “input channel” while a processing channel that performs digital signal processing on an audio signal to be output from the mixer system will be referred as an “output channel”.

The engine 20a includes a plurality of input channels 202. Each of the input channels 202 receives an audio signal from one of the input ports that has been patched thereto, then performs signal processing, such as compressor, equalizer and volume control, and then selectively outputs the thus-processed audio signal to individual buses of a mixing bus section 204. The mixing bus section 204 comprises a plurality of buses, in each of which audio signals supplied from one or more input channels are mixed so that the mixed audio signal is output to a corresponding output channel 206. The engine 20a includes a plurality of output channels 206 corresponding in number to the mixing buses of the mixing bus section 204. Each of the output channels 206 performs signal processing, such as compressor, equalizer and volume control, and on the audio signal output from the mixing bus 204. Note that the input channels 202, the mixing buses 204 and the output channels 206 are implemented by the DSP 27 of the engine 20.

On the basis of patches set on the console 10a or 10b, the output patch section 208 supplies an audio signal of each of the output channels 206 to a supply destination. For example, if a supply destination of a patch set for a given output channel 206 is an output port of another device, the output patch section 208 allocates a transmitting channel, secured in advance by the engine 20a, to the audio signal to be output by the output channel 206. The N_IO 23 transmits the audio signal, to which the transmitting channel has been allocated, by use of that transmitting channel of the second-type network 120. Further, transmission information indicative of the audio transmitting channel and the supply source to the other device connected to the second-type network 120. If a supply destination of a patch set for a given output channel 206 is an output port (“Ai(EA)”) 240a of the engine 20a, the output patch section 208 supplies an audio signal of the output channel 206 directly to an output port 240a.

On the basis of the patches set on the console 10a or 10b and the transmission information given from other devices, each of the I/O unit 30a and 30b and the engine 20b identifies transmitting channels of the second-type network 120 via which audio signals are to be received, and then the audio signals of the identified transmitting channels are set into the N_IOs 33 and 23. Then, each of the N_IOs 33 and 23 receives the audio signals of the set transmitting channels via the second-type network 120. Then, on the basis of a patch set for each of the output ports (supply destinations) provided in the devices 30a, 30b and 20b, each of the patch sections 330a, 330b and 230b (and 320a, 320b and 320b) of the devices 30a, 30b and 20b supplies an audio signal of a supply source corresponding to the patch to the output port. Namely, if a supply source of a given patch set for a given output port of a given device is an input port or a processing channel of the same device, each of the patch sections 330a, 330b and 230b (and 320a, 320b and 320b) supplies an audio signal of the input port or the processing channel to the output port. If a supply source of a given patch set for a given output port of a given device is a supply source of another device, on the other hand, each of the patch sections 330a, 330b and 230b (and 320a, 320b and 320b) supplies an audio signal of the supply source, received via the N_IO 33 or 23, to the output port.

Each of the I/O units 30a and 30b and the engine 20b outputs audio signals from its one or more output ports 340a, 340b, 240b (“Ao(OA)”, “Ao(OB)”, “Ao(EB)”) to the outside. The output ports 340a, 340b and 240b correspond to the A_IO 24 and the A_IO 34 shown in FIG. 2A.

The patch sections 310a, 310b 330a and 330b of the individual I/O units, the patch sections 210b and 230b of the engine 20b and the input patch section 200 and the output patch section 208 of the engine 20a each can be implemented by a construction where the blocks (N_IOs 13, 23 and 33, A_IOs 14, 24 and 34 and DSP 27) interconnected via the audio buses 19, 29 and 39 of the individual devices are caused to function as patch sections, or a construction where hardware dedicated to a patch function is provided in each of the N_IOs 13, 23 and 33.

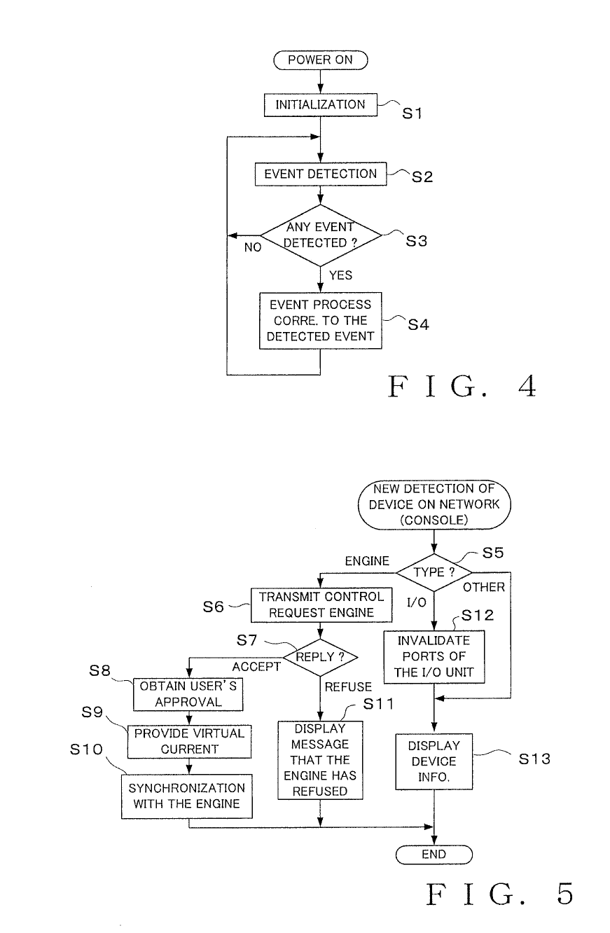

FIG. 4 is a flow chart of main processing performed by each of the CPUs 11, 21 and 31 of the console 10, the engine 20 and the I/O unit 30. The main processing of FIG. 4 is started up upon powering-on. At step S1, each of the CPUs 11, 21 and 31 performs an initialization process, which includes initialization of the memory 12, 22, 32 and various sensors, preparation of various current memories, activation of various services operating as background processing, etc. In this specification, a region provided in a memory of a given device for storing values of various parameters for controlling operation of the device will hereinafter be referred to as a “current memory”, and a region provided in a memory of a given device for storing values of various parameters for indirectly controlling operation of another device than the given device will hereinafter be referred to as a “virtual current memory”

For example, in the initialization process of step S1, the CPU 11 of the console 10 prepares or provides in the memory 12 a current memory for the console 10 (hereinafter referred to as “actual C current”) for storing values of a plurality of parameters for controlling operation of the console 10. The actual C current has a plurality of types of parameter regions for storing, for example, parameters identifying one or more processing channels currently controlled via a UI of the console 10 (e.g., a layer parameter identifying a currently-selected channel layer and a selected channel parameter identifying a currently-selected channel), parameters identifying an audio signal currently monitored via monitor output (e.g., a monitor parameter and a CUE parameter, etc.), parameters for managing the later-described virtual current memory provided in the memory 12, etc.

Further, the CPU 21 of the engine 20 provides in the memory 22 a current memory for the engine 20 (hereinafter referred to as an “actual E current”) for storing values of a plurality of parameters for controlling operation of the engine 20. The actual E current has a plurality of types of parameter regions for storing, for example, values of parameters of individual blocks (e.g., input channel section 202, output channel section 206, individual ports 210 and 240 etc.) included in signal processing by the engine 20a shown in FIG. 3, parameters for managing a later-described virtual current memory provided in the memory 22, etc.

Further, the CPU 31 of the I/O unit 30 provides in the memory 32 a current memory for the I/O unit 30 (hereinafter referred to as an “actual I/O current”) for storing values of a plurality of parameters for controlling operation of the I/O unit 30. The actual I/O current has, for example, a parameter region for storing parameters of individual blocks included in signal processing by the I/O 30a, 30b, 30c (i.e., individual ports 310 and 340 included in the one I/O unit 30) shown in FIG. 3.

Further, in the initialization process of step S1, the CPU 11 of the console 10 provides in the memory 12 a virtual current memory (hereinafter referred to as a “virtual E current”) that corresponds to the “actual E current” of the engine 20a belonging to the first mixer system 100, and a virtual current memory (hereinafter referred to as a “virtual I/O current”) that corresponds to the “actual I/O current” of each of the I/O units 30a and 30b (and the engine 20b) belonging to the first mixer system 100. Like the corresponding actual E current, the virtual E current has a plurality of types of parameter regions for storing values of parameters of individual blocks included in signal processing by the engine 20, etc. Like the corresponding actual I/O current, the virtual I/O current has parameter regions for storing parameters of individual ports provided in the one I/O 30. Because the engine 20b is handled as an equivalent of the I/O unit 30 as noted above, it is assumed here that the engine 20b has only parameter regions for storing parameters of individual ports provided in the engine 20b similarly to the virtual I/O current.

Further, in the memory 22 of the engine 20 is provided a “virtual I/O current” corresponding to the “actual I/O current” of each of the I/O units 30a and 30b (and the engine 20b) connected to the input channel section 202 and the output channel section 206 of the engine 20. The virtual I/O current provided in the engine 20 has only parameter regions corresponding to individual ports of the I/O unit 30 connected to the input channel section 202 and the output channel section 206 of the engine 20. Namely, the virtual I/O current provided in the engine 20 is not parameter regions corresponding to all of the ports provided in one I/O unit 30, but a partial virtual I/O current including only parameter regions corresponding to some of the ports connected to any of the input channels 202 and the output channels 206 of g to some of the ports connected to any of the input channels 202 and the output channels 206 of the engine 20.

At step S2, each of the CPUs 11, 21 and 31 determines presence/absence of detection of various events (i.e., event detection). If any event has been detected (YES determination at step S3), the CPU 11, 21 or 31 performs an event process corresponding to the detected event, at step S4. Examples of the various events include a “device detection” event indicating that a device connected to the first-type network 110 or the second-type network has been newly detected, and a “user operation” event indicating that a UI operation has been performed by a human operator.

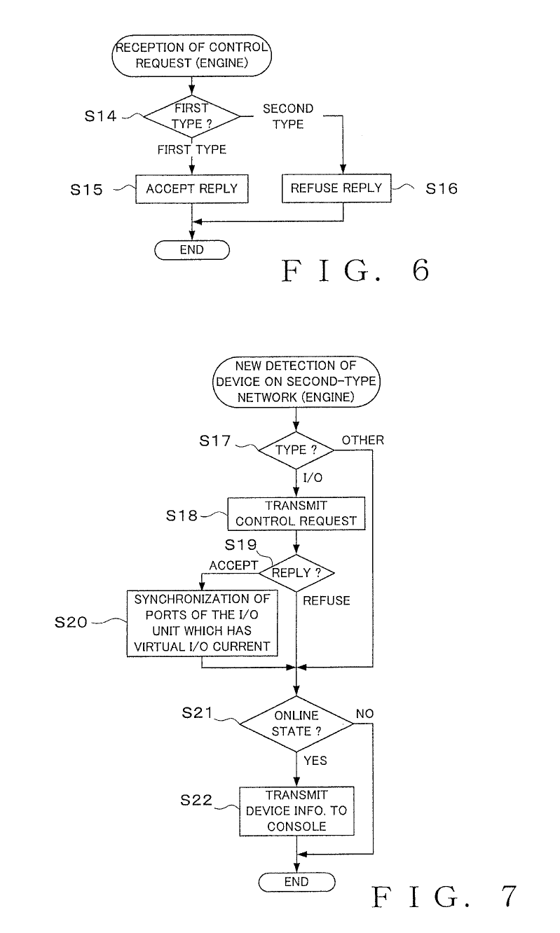

FIG. 5 is a flow chart of a process performed when the console 10 has newly detected a device (“New Detection of a Device”) on the first-type network 110 or on the second-type network 120. The process of FIG. 5 is started up, for example, when the console 10 has been newly connected to the first-type network 110 or the second-type network 120, when the console 10 connected to the first-type network 110 or the second-type network 120 has been powered on, when a device has been newly connected to the first-type network 110 or the second-type network 120 having the console 10 connected thereto, or when the device connected to the first-type network 110 or the second-type network 120 has been powered on.

At step S5, the CPU 11 of the console 10 determines a type of the newly-detected device. The type of the device to be determined here is any one of “Engine”, “I/O unit” and “Other”. For example, the CPU 11 of the console 10 can acquire, from the newly-detected device, information indicative of the type and determine the type on the basis of the acquired information. Here, for each device whose model or version is not compliant with the console 10, the CPU 11 of the console 10 determines the type to be “Other” even if the type is “Engine” or “I/O unit”.

If the type of the newly-detected device is “Engine 20” as determined at step S5 (“Engine” at step S5), the CPU 11 of the console 10 goes to step S6, where it transmits a control request to the newly-detected engine 20. If the console 10 is currently correctly connected to the first-type network 110, it transmits a control request to the newly-detected engine 20 via the first-type network 110. If the console 10 is currently erroneously connected to the second-type network 110, on the other hand, it transmits a control request to the newly-detected engine 20 via the second-type network 120. FIG. 6 is a flow chart of a process performed by the engine 20 in response to receipt of the control request transmitted from the console 10 at step S6. At step S14 of FIG. 6, the CPU 21 of the engine 20 identifies a connector of the N_IO 23 having received the control request, and then the CPU 21 determines, on the basis of the identified connector, via which of the first- and second-type network 110 and 120 the control request has been received. If the control request has been received via the first-type network 110 as determined at step S14, the CPU 21 of the engine 20 proceeds to step S15 to return a reply “Accept” to the console 10. If the control request has been received via the second-type network 110, on the other hand, the CPU 21 branches to step S16 to return a reply “Refuse” to the console 10.

Referring back to FIG. 5, once the CPU 11 of the console 10 receives the “accept” reply to the control request transmitted at step S6, the CPU 11 goes to step S8, where it obtains human an operator's approval as regards remote control thereby of the engine 20. The approval from the human operator is made, for example, by the human operator displaying an approving dialog on the panel display section.

Then, at step S9, the CPU 11 of the console 10 prepares, in the memory 12, the virtual E current corresponding to the current newly-detected engine 20. In the aforementioned initialization process of step S1, the console 10 has provided, in the memory 12, the virtual current memories (i.e., virtual E current and virtual I/O current) in corresponding relation to all of the devices belonging to the mixer system 100. Thus, if the current newly-detected engine 20 already belongs to the mixer system 100, the virtual E current corresponding to the engine 20 already exists in the memory 12 of the console 10. Therefore, at step S9, the CPU 10 acquires, from the newly-detected engine 20, identification information identifying the newly-detected device 20, such as an ID unique to the newly-detected device like a MAC address of the Ethernet (registered trademark) or a serial ID assigned to the device by a maker at the time of manufacturing of the device, or a device name or ID set by a user for the device, and then, the CPU 10 performs association (matching) between the newly-detected engine 20 and the virtual E current. If the engine 20 cannot be associated with the virtual E current, the engine 20 is newly added to the mixer system 100. Namely, the CPU 11 of the console 10 newly provides, in the memory 12, a virtual E current corresponding to the newly-added engine 20 and performs association (matching) between the engine 20 and the newly-provided virtual E current. Further, if there already exists a virtual I/O current in the memory 22 of the newly-detected engine 20, the CPU 11 provides, in the memory 12 of the console 10 too, a virtual I/O current corresponding to the virtual I/O current in the memory 22.

Then, at step S10, the CPU 11 performs setting such that values of a plurality of parameters of the virtual E current and a plurality of parameters of each virtual I/O current stored in the memory 12 of the console 10 at step S9 above match a plurality of parameters of the actual E current and a plurality of parameters of each virtual I/O current stored in the memory 22 of the current newly-detected engine 20, after which the CPU 11 terminates the instant process. Hereinafter, performing setting such that values of a plurality of parameters of a current memory or a virtual current memory stored in a memory of a given device match values of a plurality of corresponding parameters of a current memory or a virtual current memory stored in another device will hereinafter be referred to as “synchronizing” or “synchronization”. Regarding virtual I/O currents, synchronization is performed only for a virtual I/O current corresponding to the I/O unit 30 already detected by the engine 20 in a later-described process of FIG. 7. Synchronization between the console 10 and the engine 20 may be performed in such a direction that values of parameters of the engine 20 are caused to match values of parameters of the console 10, or conversely in such a direction that values of parameters of the console 10 are caused to match values of parameters of the engine 20. A desired direction of the synchronization can be determined, for example, manually by a human operator's instruction. By the above-mentioned synchronization, the newly-detected engine 20 and the I/O unit 30 already detected by the engine 20 are placed in a state capable of being remote-controlled via the console 10, and a message to the effect that the engine 20 and the I/O unit 30 have been placed in an online state is displayed on the panel display section 17 of the console 10. Thus, on the condition that the console 10 is currently connected to the first-type network 110, the console 10 can start remote control on the engine 20 and the I/O unit 30 connected with the engine 20 via the second-type network 120.

If the “Refuse” reply has been received from the engine 20 (“Refuse” at step S7), on the other hand, the CPU 11 of the console 10 goes to step S11 to display on the panel display section 17 a message to the effect that the engine 20 has refused remote control, after which the CPU 11 terminates the instant process. At step S11, a warning that the console 10 has been erroneously connected to the second-type network 120 may also be displayed. Thus, if the console 10 has been erroneously connected to the second-type network 120 (i.e., if the console 10 has been erroneously connected to the engine 20 via the second-type network 120), remote control, by the console 10, on the engine 20 and the I/O unit 30 is invalidated. In other words, while the engine 20 accepts remote control by the console 10 connected to the engine via the first-type network 110, it refuses remote control by the console 10 connected to the engine via the second-type network 120. Further, by the engine 20 refusing the control request, the console 10 can be reliably prevented from being used erroneously connected to the second-type network 120.

The aforementioned operations of steps S5 to S11 performed by the CPU 11 of the console 10 and a later-described operation of step S22 (FIG. 7) function as a remote control setting means which validates remote control, by the control device, on the processing device and the input/output device when the control device is connected to the first-type network, but invalidates remote control, by the control device, on the processing device and the input/output device when the control device is connected to the second-type network.

Further, the aforementioned operations of steps S14 to S16 performed by the CPU 21 of the engine 20 function as a determination means which accepts remote control by the control device when the control device is connected to the processing device via the first-type network, but refuses the remote control by the control device when the control device is connected to the processing device via the second-type network.

Referring back to FIG. 5, if the type of the newly-detected device is “I/O Unit 30” (“I/O” at step S5), the CPU 11 of the console 10 goes to step S12, where it invalidates input/output of audio signals to/from the I/O unit 30. Namely, the CPU 11 of the console 10 performs control so as not to allocate a transmitting channel of the first-type network 110 to any one of the ports of the I/O unit 30. Thus, the I/O unit 30 becomes a device that ignores communications on the first-type network. Then, the CPU 11 of the console 10 displays, at step S13, device information, such as a model name, of the current newly-detected I/O unit 30 on the panel display section 17, after which the CPU 11 of the console 10 terminates the instant process. Further, a warning that the I/O unit 30 has been erroneously connected to the first-type network 110 may be displayed. By thus invalidating input/output of audio signals to/from the I/O unit 30 when the console 10 has newly detected the I/O unit 30, the I/O unit 30 can be reliably prevented from being used erroneously connected to the first-type network 110. As noted above, erroneous connection of the console 10 to the second-type network 120 can be prevented by the “Refuse” at step S7 and by the display at step S11. Thus, an erroneous connection state where the console 10 is connected to the I/O unit 30 via the second-type network 120 can be prevented by the “Refuse” reply at step S7 and by the display at step S11.

The aforementioned operation of step S12 performed by the CPU 11 functions as an input/output setting means which validates input/output of audio signals in or to/from the input/output device when the input/output device is connected to the second-type network, but invalidates input/output of audio signals in the input/output device when the input/output device is connected to the first-type network. Note that the function as the input/output setting means (i.e., the operation of step S12) may be performed by the CPU 31 of the I/O unit 30. In short, it is only necessary that at least one of the console (control device) 10 and the I/O unit (input/output device) 30 invalidate input/output of audio signals to/from the input/output device when the input/output device is connected to the first-type network.

Furthermore, if the type of the newly-detected device is other than “Engine 20” and “I/O unit 30”, or if the type of the newly-detected engine 20 or I/O unit 30 has been determined to be “Other” at step S5 because the model or version of the newly-detected engine 20 or I/O unit 30 is not compliant with the console 10, the CPU 11 goes to step S13, where it displays, on the panel display section 17, information of the newly-detected device or a message to the effect that the model or version of the newly-detected device is not compliant with the console 10. If the newly-detected device is another console than the console 10, the CPU 11 of the console 10 conducts negotiation with the newly-detected console so as to achieve unification, between the two consoles, of various information about the first mixer system (information of various devices belonging to the mixer system, current time, sampling frequency, etc.), after which the CPU 11 starts operation of the newly-detected console. In this case, the signal processing of the first mixer system 100 can be controlled by a UI operation on any one of the existing console 10 and the newly-detected console (for example, the console 10a and the console 10a in the first mixer system 100).

FIG. 7 is a flow chart of a process performed when the engine 20 has newly detected a device on the second-type network 120. The process of FIG. 7 is started up, for example, when the engine 20 has been newly connected to the second-type network 120, when the engine 20 connected to the second-type network 120 has been powered on, when a device has been newly connected to the second-type network 120 having the engine 20 connected thereto, or when the device connected to the second-type network 120 has been powered on.

At step S17, the CPU 21 of the engine 20 determines a type of the newly-detected device. For example, at step S17, the CPU 21 determines whether or not the type of the newly-detected device is “I/O unit”. Note that, even where the type of the newly-detected device is “I/O unit”, the type is determined to be “Other” than “I/O unit” if a model or version of the newly-detected device is not compliant with the engine 20 in question. If the newly-detected device is “I/O Unit 30” (“I/O” at step S17), the CPU 21 goes to step S18, where it transmits a control request to the I/O unit 30 to the newly-detected I/O unit 30.

In response to the control request received from the engine 20, the I/O unit 30 returns a reply “Accept” or “Refuse” to the engine 20. For example, if the version of the I/O unit 30 is not compliant with the engine 20, or if all of the ports provided in the I/O unit 30 are set dedicated to another mixer system (i.e., none of the ports provided in the I/O unit 30 are set at “I/O share”), the I/O unit 30 returns the “Refuse” reply to the engine 20.

If the “Accept” reply has been received from the newly-detected I/O unit 30 (“Accept” at step S19), the CPU 21 of the engine 20 synchronizes, at step S20, between the virtual I/O current stored in the memory 22 and the actual I/O current stored in the memory 32 of the newly-detected I/O unit 30. If the newly-detected I/O unit 30 already belongs to the mixer system 100, it means that the virtual I/O current corresponding to the newly-detected I/O unit 30 (or virtual I/O current corresponding to some of the ports of the newly-detected I/O unit 30) has already been provided in the memory 22 through the initialization process of step S1, and thus, the CPU 21 of the engine 20 associates the virtual I/O current already provided in the memory 22 and the newly-detected I/O unit 30. If the newly-detected I/O unit 30 does not yet belong to the mixer system 100, the CPU 21 of the engine 20, after having received an approval by the human operator, newly provides a virtual I/O current corresponding to the newly-detected I/O unit 30 and then associates the newly-provided virtual I/O current and the actual I/O current of the newly-detected I/O unit 30. Note that such synchronization is performed only for each port for which a corresponding parameter region is provided in the virtual I/O current in the memory 22 of the engine 20. Let it be assumed here that the direction of the synchronization is from the engine 20 to the I/O unit 30 (i.e., values of a plurality of parameters of the actual I/O current of the corresponding I/O unit 30 are caused to match values of a plurality of parameters of the virtual I/O current in the engine 20). Note that the parameter region for each port in the virtual I/O current may be created, for example, after a connection between a given processing channel of the engine and that port is set.

At step S21, the CPU 21 of the engine 20 determines whether the engine 20 is currently in an online state with the console 10 on the first-type network 110. For example, if the engine 20 has been synchronized with the console 10 at step S10 of FIG. 5 and is currently being remote-controlled via the console 10, the CPU 21 determines that the engine 20 is currently in an online state with the console 10.

If the engine 20 is currently in an online state (YES determination at step S21), the CPU 21 of the engine 20 proceeds to step S22 to transmit to the console 10, which is a remote controller, device information identifying the newly-detected I/O unit 30, after which the CPU 21 terminates the instant process. Such device information is transmitted to the console 10 via the first-type network 110. If the engine 20 is not currently in an online state, i.e., is in an offline state, (NO determination at step S21), on the other hand, the CPU 21 terminates the instant process.

On the other hand, if the control request has been refused by the newly-detected I/O unit (“Refuse” at step S19), or if the newly-detected I/O unit is “Other” than “I/O unit” (“Other” at step S17), or if the model or version of the newly-detected I/O unit is not compliant with the engine 20 (“Other” at step S17), the process proceeds to step S21. Then, if the engine 20 is currently in an offline state (NO determination at step S21), on the other hand, the CPU 21 of the engine 20 terminates the instant process. If the engine 20 is currently in an online state with the console 10 (YES determination at step S21), the CPU 21 of the engine 20 transmit to the console 10 device information identifying the newly-detected device (at step S22 above), after which the CPU 21 terminates the instant process.

The console 10, having received the device information from the engine 20 as a result of the operation at step S22, provides, in the memory 12, a virtual I/O current corresponding to the newly-detected I/O unit 30 through an operation similar to that of step S9. Namely, if the newly-detected I/O unit 30 belongs to the mixer system 100, the virtual I/O current corresponding to the newly-detected I/O unit 30 has already been provided in the memory 12, and thus, the CPU 11 of the console 10 associates the virtual I/O current provided in the memory 22 and the newly-detected I/O unit 30. If the newly-detected I/O unit 30 does not yet belong to the mixer system 100, on the other hand, the CPU 11 of the console 10, after having received an approval from the human operator, newly provides a virtual I/O current in the memory 12 and then associates the newly-provided virtual I/O current and the newly-detected I/O unit 30. Then, the virtual I/O currents stored in the memory 12 of the console 10 and in the memory 22 of the engine 20 and the actual I/O current of the newly-detected I/O unit 30 are synchronized with each other, so that the newly-detected I/O unit 30 is not only placed in a state capable of being remote-controlled via the console 10 but also displayed, as a device in an online state, on the panel display section 17.

If the engine 20 has newly detected, on the second-type network 120, an engine 20 using only ports in the mixer system 100 (e.g., if the engine 20a has newly detected the engine 20b on the second-type network 120), the CPU 21 of the engine 20a (and the CPU 11 of the console 10) provide a virtual current memory corresponding to the engine 20b (i.e., virtual current memory, similar to the virtual I/O current, which has only parameter regions corresponding to ports connected to the individual processing channels), and the CPU 21 synchronizes between the virtual current memory and various port-related parameters (parameters of the ports and parameters of connections of the ports) in the actual E current of the engine 20b.

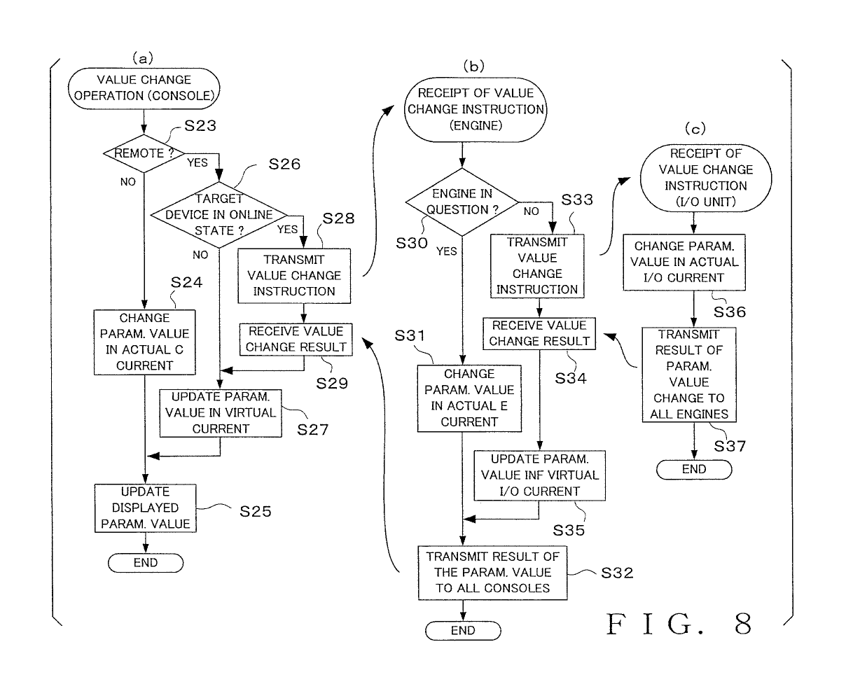

The following describe a parameter value change process responsive to a value change operation by a human operator. The human operator of the console 10 performs a value change operation of a parameter by operating a UI member (e.g., moving a knob or operating a switch) having the parameter allocated thereto on the UI (panel operation section 16 or panel display section 17) of the console 10. (a) of FIG. 8 is a flow chart of a process performed by the CPU 11 of the console 10 in response to a value change operation of a given parameter.

At step S23, the CPU 11 of the console 10 determines whether an object of the value change operation is local control of the console 10 or remote control of another device than the console 10. If the object of the value change operation is the local control (NO determination at step S23), the CPU 11 of the console 10 goes to step S24 to change a parameter value stored in the actual C current in response to the value change operation. Then, the CPU 11 proceeds to step S25 to update the parameter value displayed on the panel display section 17 in accordance with a result of the parameter value change in the actual C current, after which the CPU 11 terminates the instant process.

If the object of the value change operation is the remote control (YES determination at step S23), the CPU 11 determines, at step S26, whether a device set as a target of the remote control (hereinafter “target-of-remote-control device”) is currently in an offline state. If the target of the remote control is in an offline state (NO determination at step S26), the CPU 11 of the console 10 goes to step S27, where, on the basis of the current value change operation, it changes the value of the parameter of one of the device-specific virtual current memories, provided in the memory 12 of the console, which corresponds to the target-of-remote-control device. Then, the CPU 11 updates, in accordance with an updated result of the virtual current memory, the value of the parameter of the virtual current memory displayed on the panel display section 17 (step S25 above), after which the CPU 11 terminates the instant process.

If the object of the value change operation is the remote control (YES determination at step S23) and the target-of-remote-control device is currently in an online state (YES determination at step S26), the CPU 11 of the console 10 goes to step S28 to transmit a value change instruction to the target-of-remote-control device via the first-type network 110.

The value change instruction transmitted from the console 10 at step S28 is received by the engine 20 connected to the first-type network. (b) of FIG. 8 is a flow chart of a process performed by the CPU 21 of the engine 20 in response to receipt of the value change instruction via the first-type network 110. At step S30, the CPU 21 of the engine 20 determines, at step S30, whether a target of the received value change instruction is the engine 20 in question or another device than the engine 20.

If the target of the value change instruction received from the console 10 is the engine 20 in question (YES determination at step S30), the CPU 21 of the engine 20 goes to step S31, where, in accordance with the received value change instruction, the CPU 21 changes (increases or decreases) the value of the corresponding parameter in the actual E current of the memory 22 of the engine 20. Thus, the value change operation performed on the console 10 is reflected in the actual E current of the engine 20. Then, at step S32, the CPU 21 of the engine 20 transmits a result of the parameter value change at step S31 to all of the consoles 10 (consoles 10a and 10b in the first mixer system 100 in FIG. 1) connected to the first-type network 110.

At step S29 of (a) of FIG. 8, the console 10 receives the result of the parameter value change transmitted from the engine 20 at step S32. Then, the CPU 11 of the console 10 updates, in accordance with the received result of the parameter value change, the value of the corresponding parameter in the virtual E current, corresponding to the engine 20 having transmitted the result of the parameter value change, so as to match the value of the parameter in the actual E current of the engine 20 (step S27). The CPU 11 of the console 10 also updates, in accordance with an updated result of the virtual E current, the value of the parameter displayed on the panel display section 17 (step S25). Thus, the value of the corresponding parameter in the virtual E current of the console 10 is changed in accordance with the changed result of the value of the parameter in the actual E current of the engine 20 responsive to the human operator's operation on the console 10.

Referring back to (b) of FIG. 8, if the target of the value change instruction received from the console 10 is another device than the engine 20 (NO determination at step S30), the CPU 21 of the engine 20 proceeds to step S33, where it transmits the received value change instruction to the object-of-remote-control device via the second-type network 120. For example, if the target of the value change instruction received by the engine 20a from the console 10a is the I/O unit 30a, the engine 20 forwards the value change instruction, received from the console 10 via the first-type network 110, to the I/O unit 30a via the second-type network 120. The operations of steps S30 and S33 performed by the CPU 21 of the engine 20 constitute a process for bridging communication between the console (control device) 10 connected to the first-type network 110 and the I/O unit (input/output device) 30 connected to the second-type network 120.

The value change instruction transmitted from the engine 20 at step S33 is received by the I/O unit 30 designated as a destination from among one or more devices on the second-type network 120. (c) of FIG. 8 is a flow chart of a process performed by the CPU 31 of the I/O unit 30 in response to receipt of the value change instruction via the second-type network 120. Note that, of the one or more devices on the second-type network 120, each device that is not a destination of the value change instruction ignores the value change instruction.

At step S36 of (c) of FIG. 8, the CPU 31 of the I/O unit 30 changes, in accordance with the received value change instruction, the value of the corresponding parameter in the actual I/O current of the memory 32. Then, at step S37, the CPU 31 transmits a result of the parameter value change at step S36 to all of the engines 20 connected to the second-type network 120.

The engine 20 receives, via the second-type network 120, the result of the value change transmitted from the I/O unit 30 at step S37 (step S34 of (b) of FIG. 8). Then, at step S35, the CPU 21 of the engine 20 updates, in accordance with the result of the value change received from the I/O unit 30, the value of the corresponding parameter in the virtual I/O current so as to match a value of the parameter in the actual I/O current of the I/O unit 30, but also transmits the result of the value change, received from the I/O unit 30, to all of the consoles 10 belonging to the first-type network 110 having the engine 20 connected thereto (step S32). Because only one or more virtual I/O currents corresponding to the ports connected to the processing channels of the engine 20 is stored in the memory 22 of the engine 20 as set forth above, update of the virtual I/O current at step S35 and transfer of the result of the value change (at step S32) are performed only in the engine 20 having the virtual I/O current corresponding to the parameter-value-changed port. Each engine 20 that does not have such a virtual I/O current corresponding to the value-changed port ignores information of the result of the value change.

The console 10 receives the result of the parameter value change transmitted from the I/O unit 30 (aforementioned step S29). Then, the CPU 11 of the console 10 updates, in accordance with the received result of the parameter value change, the value of the corresponding parameter in the virtual I/O current, corresponding to the I/O unit 30 that is a transmission source having transmitted the result of the parameter value change, so as to match the value of the corresponding parameter in the actual I/O current of the I/O unit 30 or the transmission source (step S27). The CPU 11 of the console 10 also updates, in accordance with an updated result of the virtual I/O current, the value of the parameter displayed on the panel display section 17 (aforementioned step S25). Thus, the value of the corresponding parameter in the virtual I/O current of the engine 20 and the value of the corresponding parameter in the virtual I/O current of the console 10 are each changed in accordance with the changed result of the value of the parameter in the actual I/O current of the virtual I/O engine 30 responsive to the human operator's operation on the console 10.

The above-described embodiment of the mixer system 100 includes two types of networks, i.e., the first-type network 110 for transmitting remote controlling data from the console 10 to the engine 20, and the second-type network 120 for communicating a multiplicity of audio signals between the engine 20 and the I/O unit 30. The mixer system 100 including such two types of networks is constructed to prevent the console 10 from being used erroneously connected to the second-type network 120 and prevent the I/O unit 30 from being used erroneously connected to the first-type network 110. With such arrangements, the mixer system 100 can prevent deterioration of a response to a human operator's operation in remote control of the engine 20 and the I/O unit 30 via the console 10, but also can prevent reduction of bands of the second-type network 120 to be used for communication of audio signals and thereby sufficiently exert audio signal transmission performance. As a result, the mixer system 100 can perform more stable remote control and audio processing.

Whereas the engine 20 has been described as arranged to determine, at step S14 of FIG. 6, whether it should accept or refuse the control request from the console 10 depending on via which of the first- and second-type network 120 the control request has been received from the console 10. In addition to such a determination condition of “via which of the first- and second-type network 120 the control request has been received from the console 10”, the model of the console or version of firmware may be used as such a determination condition. In such a case, if the console 10 having transmitted the control request is currently connected to the first-type network 110 and the model and version of the console 10 are compliant with the engine 20, the engine 20 returns the “accept” reply.

In the foregoing description about the embodiment, the virtual I/O current stored in the memory 22 of the engine 20 has been described as only having parameter regions corresponding to ports connected to processing channels of the engine 20, as an example implementation for storing only parameters for ports connected to processing channels of the engine 20. As another implementation, parameter regions corresponding to all of the ports provided in one I/O unit may be provided, in which case the parameter regions for ports connected to any of the processing channels of the engine 20 are “validated” while the parameter regions for ports connected to none of the processing channels of the engine 20 are “invalidated”.

Note that personal computers (PCs) 40 can be connected to the console 10 or to the engine 20 on the first-type networks 110 and 115 as shown in FIG. 1. In such a case, the PC 40 executing a remote-controlling application program of the mixer system in place of the UI of the console 10 may be arranged to function as a control device that controls an audio signal input/output function and processing function in response to a human operator's operation. Also note that such personal computers may be of any form, such as a portable terminal like a tablet terminal or a smart phone, or a virtual machine. In the illustrated example of FIG. 1, the PC 40a is connected to the console 10b, in which case the PC 40a can function as a control device of the first mixer system 100 similarly to the console 10a or 10b. Further, where the PC 40b is connected to the engine 20c as in the second mixer system 105, operation of the engine 20c and the engine 20b and the I/O units 30b and 30c on the second-type network 120 can be remote-controlled by UI operations on the PC 40. In such a case, signal processing can be continued in the second mixer 105 by use of the PC 40b even after the console 10c is powered off.

Note that, in the embodiment of the mixer system 100, the virtual I/O current is stored in the memory 22 of the engine 20. Thus, even where the console 10 is not connected to the first-type network 110, signal processing of the engine 20 can be continued as long as the engine 20 and the virtual I/O 30 are interconnected via the second-type network 120. Consequently, even after the console 10 on the first-type network 110 is powered off, for example, audio signal processing can be continued. In such a case, a human operator can adjust values of mixing processing parameters, for example, by use of the UI 26 of the engine 20 and can remote-control operation of the engine 20 by use of the PC 40 connected to the engine 20.

Also note that the digital signal processing performed by the engine 20 on audio signals may be of any other desired digital signal processing than the mixing processing of FIG. 3, such as audio signal characteristic control processing, analyzation processing and reverberation impartment processing.

The mixer system 100 may be constructed in any desired manner as long as at least one console (control device) 10 and one or more engines 20 are interconnected via one first-type network 110 dedicated to the mixer system 100 but also the one or more engines 20 connected to the first-type network 110 and one or more I/O units 30 (and a desired device where ports are usable) are interconnected via at least one second-type network 120. A modification of the mixer system 100 may be constructed, for example, in such a manner that, by expanding the N_IO 23 of the engine 20 so that the one mixer system 100 can be connected to a plurality of second-type networks 120, the one mixer system 100 includes one first-type network 110 and a plurality of second-type networks 120. In such a case, audio signal transmitting bands (the number of transmitting channels) in the entire mixer system can be expanded by virtue of the expansion of the second-type network

Further, the individual devices 10, 20 and 30 and the first- and second-type networks and 120 constituting the mixer systems 100 and 105 may be built on a virtual machine or a virtual network implemented on a cloud or a computer.

Furthermore, the audio processing system of the present invention is not limited to application to the mixer system and may be applied to any one of the control device 10, processing device 20 and input/output device 30 constituting the mixer system 100 or 105. Moreover, the audio processing system of the present invention may be implemented with a plurality of devices rather than with a single device. In the case where the audio processing system of the present invention is implemented with a plurality of devices, various functions to be performed by the system may be shared between or among the plurality of devices; for example, the function for determining whether remote control by the control device 10 is to be validated or invalidated may be performed by one device, and the function for determining whether input/output of audio signals in (to/from) the input/output device 30 is to be validated or invalidated may be performed by another device.

It should also be noted that application of the audio processing system of the present invention is not limited to the mixing systems 100 and 105 and that the audio processing system of the present invention is also applicable to audio processing systems of other uses, such as private broadcast or announcement systems.

It should also be appreciated that the present invention can be constructed and implemented as an invention of a remote control setting method or an invention of an input/output setting method in an audio processing system which comprises: an input/output device that inputs/outputs one or more audio signals; a processing device that processes the one or more audio signals; a control device for remote-controlling the input/output device and the processing device; a first-type network for interconnecting the control device and the processing device; and a second-type network for interconnecting the processing device, connected to the first-type network, and the input/output device. Namely, the invention of the remote control setting method is a method for setting validity or invalidity of remote control by the control device, which includes a step of validating the remote control on the processing device and the input/output device when the control device is connected to the first-type network and invalidating the remote control on the processing device and the input/output device when the control device is connected to the second-type network. Further, the invention of the input/output setting method is a method for setting validity or invalidity of input/output of an audio signal in the input/output device in the audio processing system, which includes a step of validating the input/output of an audio signal in (to/from) the input/output device when the input/output device is connected to the second-type network and invalidating the input/output of an audio signal when the input/output device is connected to the first-type network. Further, the present invention can also be constructed and implemented as a program for causing a computer to perform the aforementioned remote control setting method, and as a program for causing a computer to perform the aforementioned input/output setting method.

This application is based on, and claims priority to, JP PA 2014-030826 filed on 20 Feb. 2014. The disclosure of the priority application, in its entirety, including the drawings, claims, and the specification thereof, are incorporated herein by reference.

What is claimed is:

1. An audio processing system comprising:
at least one input/output device configured to input/output an audio signal;
at least one processing device configured to process the audio signal;
at least one control device configured to remote-control the processing device and the input/output device;
a first-type network for communicatively interconnecting said control device and said processing device; and
a second-type network for communicatively interconnecting said processing device and said input/output device,
wherein said control device is further configured to invalidate remote control thereby on said processing device and said input/output device when said control device is connected to said second-type network.

2. The audio processing system as claimed in claim 1, wherein at least one of said control device and said input/output device is further configured to invalidate input/output of an audio signal in said input/output device when said input/output device is connected to said first-type network.

3. The audio processing system as claimed in claim 1, wherein said processing device connected to both of said first-type network and said second-type network is configure to bridge communication between said control device connected to said first-type network and said input/output device connected to said second-type network.

4. A method for building an audio processing system, the audio processing system comprising: at least one input/output device configured to input/output an audio signal; at least one processing device configured to process the audio signal; and at least one control device configured to remote-control the processing device and the input/output device,
said method comprising:
a step of building a first-type network for communicatively interconnecting the control device and the processing device;
a step of building a second-type network for communicatively interconnecting the processing device and the input/output device; and
a step of, when the control device is connected to the second-type network, invalidating remote control, by the control device, on the processing device and the input/output device.

5. An audio processing system comprising:
at least one input/output device configured to input/output an audio signal;
at least one processing device configured to process the audio signal;
at least one control device configured to remote-control said processing device and said input/output device;
a first-type network for communicatively interconnecting said control device and said processing device; and
a second-type network for communicatively interconnecting said processing device and said input/output device,
wherein at least one of said control device and said input/output device is further configured to invalidate input/output of an audio signal in said input/output device when said input/output device is connected to said first-type network.

6. The audio processing system as claimed in claim 5, wherein said processing device connected to both of said first-type network and said second-type network is configure to bridge communication between said control device connected to said first-type network and said input/output device connected to said second-type network.

7. A method for building an audio processing system, the audio processing system comprising: at least one input/output device configured to input/output an audio signal; at least one processing device configured to process the audio signal; and at least one control device configured to remote-control the processing device and the input/output device,
said method comprising:
a step of building a first-type network for communicatively interconnecting the control device and the processing device;
a second-type network for communicatively interconnecting the processing device and the input/output device; and
a step of, when the input/output device is connected to the first-type network, invalidating input/output of an audio signal in the input/output device.

8. A control device in an audio processing system, the audio processing system comprising: at least one input/output device configured to input/output an audio signal; at least one processing device configured to process the audio signal; the control device configured to remote-control said processing device and said input/output device; a first-type network for communicatively interconnecting said control device and said processing device; and a second-type network for communicatively interconnecting said processing device, connected to said first-type network, and said input/output device,
wherein said control device is further configured to invalidate remote control thereby on said processing device and said input/output device when said control device is connected to said second-type network.

9. The control device according to claim 8, which is further configured to invalidate input/output of an audio signal in said input/output device when said input/output device is connected to said first-type network.

10. A non-transitory computer-readable storage medium containing a group of instructions executable by a processor to implement a remote control method in an audio processing system, the audio processing system comprising: at least one input/output device configured to input/output an audio signal; at least one processing device configured to process the audio signal; at least one control device configured to remote-control the processing device and the input/output device; a first-type network for communicatively interconnecting the control device and the processing device; and a second-type network for communicatively interconnecting the processing device, connected to the first-type network, and the input/output device,
said method comprising invalidating remote control by the control device on the processing device and the input/output device when the control device is connected to the second-type network.

11. A control device in an audio processing system, the audio processing system comprising: at least one input/output device configured to input/output an audio signal; at least one processing device configured to process the audio signal; the control device configured to remote-control said processing device and said input/output device; a first-type network for communicatively interconnecting said control device and said processing device; and a second-type network for communicatively interconnecting said processing device, connected to said first-type network, and said input/output device,
wherein said control device is further configured to invalidate input/output of an audio signal in said input/output device when said input/output device is connected to said first-type network.

12. A non-transitory computer-readable storage medium containing a group of instructions executable by a processor to implement a remote control method in an audio processing system, the audio processing system comprising: at least one input/output device configured to input/output an audio signal; at least one processing device configured to process the audio signal; at least one control device configured to remote-control the processing device and the input/output device; a first-type network for communicatively interconnecting the control device and the processing device; and a second-type network for communicatively interconnecting the processing device, connected to the first-type network, and the input/output device,
said method comprising invalidating input/output of an audio signal in the input/output device when the input/output device is connected to the first-type network.

13. A processing device in an audio processing system, the audio processing system comprising: at least one input/output device configured to input/output an audio signal; said processing device configured to process the audio signal; at least one control device configured to remote-control said processing device and said input/output device; a first-type network for communicatively interconnecting said control device and said processing device; and a second-type network for communicatively interconnecting said processing device, connected to said first-type network, and said input/output device,
wherein said processing device is further configured to accept remote control by said control device when said control device is connected to said processing device via said first-type network, and refuse the remote control by said control device when said control device is connected to said processing device via said second-type network.

14. The processing device as defined in claim 13, wherein said processing device is configure to bridge communication between said control device connected to said first-type network and said input/output device connected to said second-type network.

15. A non-transitory computer-readable storage medium containing a group of instructions executable by a processor to implement a remote control method in an audio processing system, the audio processing system the audio processing system comprising: at least one input/output device configured to input/output an audio signal; at least one processing device configured to process the audio signal; at least one control device configured to remote-control the processing device and the input/output device; a first-type network for communicatively interconnecting the control device and the processing device; and a second-type network for communicatively interconnecting the processing device, connected to said first-type network, and the input/output device,
said method comprising:
accepting remote control by the control device when the control device is connected to the processing device via the first-type network; and
refusing the remote control by the control device when the control device is connected to the processing device via the second-type network.
